(19) United States
(12) Patent Application Publication
(10) Pub. No.: US 2007/0179858 A1
(43) Pub. Date: Aug. 2, 2007

(54) Apparatus and method for optimized online shopping

(76) Inventor: Andrew Blake Jennings, Mesa, AZ (US)

Correspondence Address: WRIGHT LAW GROUP, PLLC, 7201 WEST OAKLAND, SUITE 2, CHANDLER, AZ, 85226, US

(21) Appl. No.: 11/342,211

(22) Filed: Jan. 27, 2006

(51) Int. Cl. G06Q 30/00

(52) U.S. Cl. 705/26

(57) ABSTRACT

The apparatus and methods disclosed herein implement a convenient and efficient web-browser based search-and-retrieve mechanism that incorporates a more responsive search engine coupled with an integrated collection display. The browser-based search-and-retrieve mechanism allows a user to quickly and easily retrieve a list of search items from a large database, select certain desired items, while continually having access to a visual interface displaying the collection of previously selected items. While viewing the collection of previously selected items, the search engine interface allows for the retrieval and selection of additional items from the database. In the most preferred embodiments of the present invention, the browser-based search-and-retrieve mechanism takes the form of a shopping cart with enhanced search capabilities for optimized online shopping websites. By utilizing a master index and one or more helper indices, the required search and retrieval time for selecting items from large databases can be minimized.

### BACKGROUND OF THE INVENTION

1. Field of the Invention

The present invention relates generally to the field of the Internet and more specifically relates to the use of specialized computer software to enhance interactive shopping via the Internet.

2. Background Art

The use of computers to access data via the Internet has pervaded practically every aspect of life today. Businesses can have offices around the world, all connected through the Internet, allowing employees sitting in the US to work on a project with other co-workers in offices in other sites, and even other countries. Most homes have some method in place to access this same Internet, either through the telephone lines or some form of high-speed connection such as cable, satellite, to name a few. With the world becoming increasingly connected, it is possible for individuals to do things through this ever-expanding virtual world that previously needed to be done in the real world.

One specific aspect of the Internet, more widely used than most, is the World Wide Web. People use the Web to talk to their friends, check mail, read the paper, and even shop online for goods and services that used to be purchased through “brick and mortar” retail channels. The number of online shopping options available to consumers has increased dramatically over the past few years to accommodate the growing demand for interactive online shopping. From the shopper's point of view, online shopping can eliminate much of the stress associated with the more traditional shopping experience. Moreover, online prices are generally lower than prices offered by retail merchants with a physical storefront as well. Given the current regulatory environment, most Internet purchases are also exempt from taxes. Additionally, online shopping allows customers to quickly and easily locate the desired goods and/or services, perform rapid price comparisons, and complete their purchases, all without leaving their home or office. All of this can create an opportunity for shoppers to save both time and money.

However, even with all the advantages set forth above, the online shopping experience is not entirely without drawbacks. For instance, an online shopper may actually spend more time searching for what the consumer wants, especially if he or she is unsure of what to look for or where to find it. The current search techniques used by most online vendors require that the user input their entire search request, strike a key to indicate they've finished entering the search parameters, then wait for any possible matching products. If there are no products, the consumer must try to create a new search request, and then wait again. Although the delay time for each search may only be a few seconds, when the consumer must search in several iterations to find what they want to purchase, the delay becomes significant.

After providing an appropriate search string, the consumer may be confronted with many products that match the requirements inputted as keywords. In deciding which product to ultimately buy, he or she must examine each of the products found through the search, and compare the qualities of the product against what he or she expects. Most search windows provide some of this information, namely the title and price of the product, sometimes accompanied by a photograph of the item. However the user must typically move the mouse to highlight the product and click to obtain more information about it that might be important to deciding whether to purchase or not. Even if the consumer does not require further information, he or she must still click on the link for each separate product to add it to his or her “shopping cart.”

The online “shopping cart” is, in many aspects, quite similar to a real-world shopping cart. For example, the online shopping cart is typically used to collect, hold, and display all of the products the consumer wishes to purchase, and places them together in a centralized location for eventual “checkout.” However, the real-world shopping cart is more well suited to address the needs of the consumer selecting products from the shelves, as the consumer can easily see all of the items that have been selected for purchase, and using this information, decide whether or not to select a new item. In the online shopping world, however, the shopping cart is generally separated from the search menu because the search engine and the shopping cart are not presented on the same screen.

The visual separation between the shopping cart window and the search window implemented by most ecommerce shopping sites creates a visual and logical disconnect for users who may, at times, need to go back and forth between these windows before deciding whether to purchase the product or not and to determine whether or not the appropriate items are in their electronic shopping cart. This process can be distracting to the consumer, and can be enough to turn some potential consumers away from using this form of commerce. As online shopping becomes a more prevalent way of purchasing for the consumer and, for the vendor, a more effective method of reaching the consumer, it is increasingly important to make the transition between the real world and the online shopping world as smooth as possible.

While the various presently known implementations of online shopping are not without merit, most existing methods of conducting online shopping have one or more significant drawbacks, such as search methodology and data access limitations, disjointed information presentation, or the like. In these situations and with the current technology, additional opportunities for the streamlined processing of online shopping transactions are similarly limited and lack significant potential for growth and widespread adoption. Additionally, given the current limitations inherent in the existing technology, online vendors are not likely to experience the most optimal customer acquisition and sales growth path. Accordingly, without developing improved methods of simplifying and streamlining the online shopping experience, the entire online shopping process will continue to be sub-optimal for all entities involved in the process.

### SUMMARY OF THE INVENTION

The apparatus and methods disclosed herein implement a convenient and efficient web-browser based search-and-retrieve mechanism that incorporates a more responsive search engine coupled with an integrated collection display. The browser-based search-and-retrieve mechanism allows a user to quickly and easily retrieve a list of search items from a large database, select certain desired items, while continually having access to a visual interface displaying the collection of previously selected items. While viewing the collection of previously selected items, the search engine interface allows for the retrieval and selection of additional items from the database. In the most preferred embodiments of the present invention, the browser-based search-and-retrieve mechanism takes the form of a shopping cart with enhanced search capabilities for optimized online shopping websites. By utilizing a master index and one or more helper indices, the required search and retrieval time for selecting items from large databases can be minimized.

### BRIEF DESCRIPTION OF THE DRAWINGS

The preferred embodiments of the present invention will hereinafter be described in conjunction with the appended wherein like designations denote like elements and:

FIG. 1 is a block diagram of a computer system for implementing a web-browser based search-and-retrieve mechanism in accordance with a preferred exemplary embodiment of the present invention;

FIG. 2 is a block diagram of a data server used for implementing a web-browser based search-and-retrieve mechanism in accordance with a preferred exemplary embodiment of the present invention;

FIG. 3 is a flow chart for creating a master database index for optimized searching via a web-browser based search-and-retrieve mechanism in accordance with a preferred exemplary embodiment of the present invention;

FIG. 4 is a flow chart for creating a helper database index for optimized searching via a web-browser based search-and-retrieve mechanism in accordance with a preferred exemplary embodiment of the present invention;

FIG. 5 is a flow chart for a method of enhanced database access for a user utilizing a web-browser based search-and-retrieve mechanism in accordance with a preferred exemplary embodiment of the present invention;

FIGS. 6, 6A, 6B, and 6C are a schematic representation for the construction of an index in accordance with a preferred embodiment of the present invention; and

FIG. 7 is a schematic representation of a user interface of the web-browser based search-and-retrieve mechanism of the present invention customized for optimized online shopping in accordance with a preferred exemplary embodiment of the present invention.

### DETAILED DESCRIPTION

The apparatus and methods disclosed herein implement a convenient and efficient web-browser based search-and-retrieve mechanism that incorporates a more responsive search engine coupled with an integrated collection display. The browser-based search-and-retrieve mechanism allows a user to quickly and easily retrieve a list of search items from a large database and select certain desired items, while continually having access to a visual interface displaying the collection of previously selected items. While viewing the collection of previously selected items, the search engine interface allows for the retrieval and selection of additional items from the database. In the most preferred embodiments of the present invention, the browser-based search-and-retrieve mechanism takes the form of a shopping cart with enhanced search capabilities for optimized online shopping websites.

For purposes of explanation, various terms that are used in the description of the various preferred embodiments of the present invention are set forth herein. In a typical search process, a user will generally type in one or more text characters (i.e., the “Search Term(s)”) that are representative of the items that are to be searched for and expects to see a list of things (“Matching Items”) that match the Search Terms and are returned to the user. The collection of all possible things that are being searched (i.e., database items) will be called the “Candidate Items,” and any one item in this collection may be referred to as a “Candidate Item.” In the case of an online shopping website, The Candidate Items are the products offered for sale at a given time by the online store.

In most standard search engine applications, the user must generally type in the entire Search Terms and initiate the search by pressing a key or clicking on a button before any Matching Items are returned for inspection. In the most preferred embodiments of the present invention, the Matching Items will begin to appear as the Search Terms are entered by the user.

In the most preferred embodiments of the present invention, each Candidate Item has a string of text (the “Description”) associated with it to help determine whether or not the Candidate Item matches a given Search Term. In a standard search process, a Candidate Item matches a Search Term if the Description for that Candidate Item contains each and every word or text fragment contained in the Search Term.

In contrast, the various preferred embodiments of the present invention contemplates a situation where the last word of the Search Term does not have extra non-word characters after it and this last word is considered a “Partial Word.” Additionally, every other word in the Search Term is considered a “Full Word,” regardless of whether or not the Full Word is a complete word in any given language. In this case, a Candidate Item matches a Search Term if the Description for that Candidate Item contains every Full Word in the Search Term and also contains at least one word that starts with the Partial Word from the Search Term. For the various preferred embodiments of the present invention, where the last word of a Search Term has non-word characters after it, all words in the Search Term are considered Full Words and a Candidate Item matches a Search Term if the Description for a given Candidate Item contains every word in the Search Term. This is substantially the same process as deployed in standard search methodologies.

For the most preferred embodiments of the present invention, the Candidate Items (or products in the online store) will typically have both a title and a caption, either of which may contain HTML codes that are used on the website in conjunction with displaying the Candidate Items. The text from the title and description for the Candidate Item are concatenated and the HTML codes stripped out of the text, thereby creating the Description for each Candidate Item. These descriptions are then used in one or more indices and are used to present information about Matching Items as they are located.

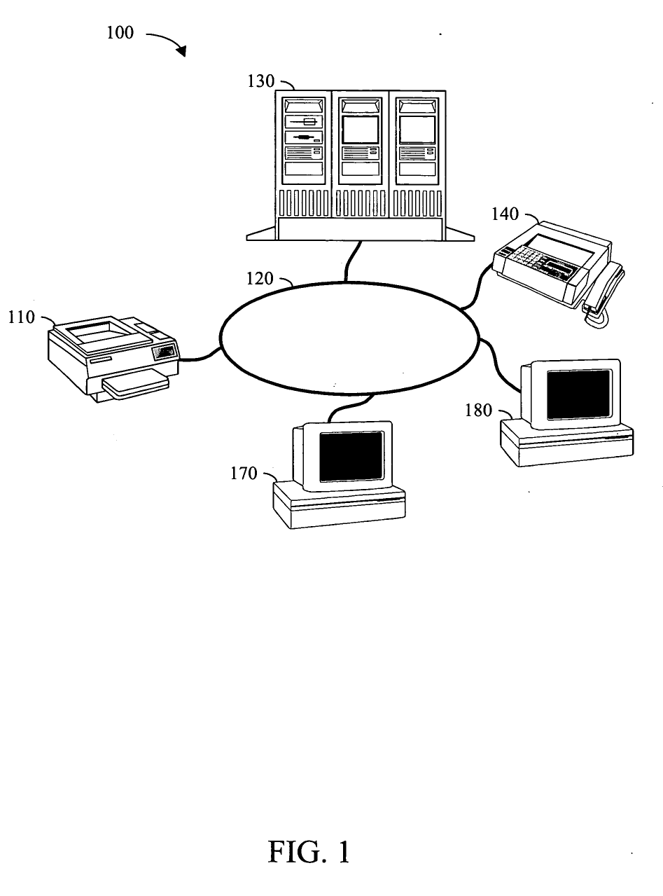

Referring now to FIG. 1, a block diagram of a computer-based system 100 for implementing and deploying a convenient and efficient web-browser based search-and-retrieve mechanism in accordance with a preferred embodiment of the present invention comprises: a data server 130; a computer system 170; and a computer system 180, all connected or coupled via a network 120. Additionally, an optional printer 110 and an optional fax machine 140 are shown. Taken together, the components of computer-based system 100 provide a way for users to access one or more large databases, search one or more of the databases, and retrieve the desired information from any of the databases as described herein in conjunction with the various preferred embodiments of the present invention. While the present invention will be described in detail by using the example of an ecommerce shopping application, those skilled in the art will recognize that the methods and techniques described herein have broad application to other applications where quick and efficient access to one or more large databases is desirable.

Data server 130 represents a relatively powerful computer system that is made available to computer system 170 and computer system 180 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art. Given the relative advances in the state-of-the-art computer systems available today, it is anticipated that functions of data server 130 may be provided by many standard, readily available data servers. Depending on the desired size and relative power required for data server 130, storage area network (SAN) technology may also be deployed in certain preferred embodiments of the present invention. Additionally, various biometric and identification verification devices for creating and verifying digital signatures (i.e., electronic signature processing) may also be included.

Computer system 170 may be any type of computer system known to those skilled in the art that is capable of being configured for use with computer-based system 100 as described herein. This includes laptop computers, desktop computers, tablet computers, pen-based computers and the like. Additionally, handheld and palmtop devices are also specifically included within the description of devices that may be deployed as a computer system 170. It should be noted that no specific operating system or hardware platform is excluded and it is anticipated that many different hardware and software platforms may be configured to create computer system 170. As previously explained in conjunction with data server 130, various hardware components and software components (not shown this FIG.) known to those skilled in the art may be used in conjunction with computer system 170. It should be noted that in the most preferred embodiments of the present invention, computer system 170 is linked to its own LAN or WAN and has access to its own data server (not shown-this FIG.).

Similarly, computer system 180 may be any type of computer system known to those skilled in the art that is capable of being configured for use with computer-based system 100 as described herein. This includes laptop computers, desktop computers, tablet computers, pen-based computers and the like. Additionally, handheld and palmtop devices are also specifically included within the description of devices that may be deployed as a computer system 180. It should be noted that no specific operating system or hardware platform is excluded and it is anticipated that many different hardware and software platforms may be configured to create computer system 180. As previously explained in conjunction with data server 130, various hardware and software components (not shown this FIG.) known to those skilled in the art may be used in conjunction with computer system 180. It should also be noted that in the most preferred embodiments of the present invention, computer system 180 is linked to its own LAN or WAN and has access to its own data server (not shown this FIG.).

Network 120 is any suitable computer communication link or communication mechanism, including a hardwired connection, an internal or external bus, a connection for telephone access via a modem, standard co-axial cable lines, high-speed T1 line, radio, infrared or other wireless communication methodologies, private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, broadcast cable transmission line, Digital Subscriber Line (DSL), ISDN line, or similar public utility-like access link.

In the most preferred embodiments of the present invention, at least a portion of network 120 comprises a standard Internet connection between the various components of computer-based system 100. Network 120 provides for communication between the various components of computer-based system 100 and allows for relevant information to be transmitted from device to device. In this fashion, a user of computer-based system 100 can quickly and easily gain access to the relevant data and information utilized to search, retrieve, and display information from one or more databases as described in conjunction with the preferred embodiments of the present invention. Regardless of physical nature and topology, network 120 serves to logically link the physical components of computer-based system 100 together, regardless of their physical proximity, thereby enabling communication between the components. This is especially important because in many preferred embodiments of the present invention, data server 130, computer system 170, and computer system 180 may be geographically remote and physically separated from each other.

In general, data server 130 processes requests for retrieving data from one or more databases located on data server 130 made by the users of computer system 170 and/or computer system 180. A typical transaction may be represented by a request for retrieving a certain type or number of products in conjunction with an on-line shopping session. In this case, a request to access a given shopping website's database of products is sent from computer system 170 and/or computer system 180 to data server 130. Data server 130 processes the request to access one or more databases and takes the specific action requested by computer system 170 and/or computer system 180, typically by retrieving and returning data to computer system 170 and/or computer system 180. The request may be directed towards locating a specific item in a database, comparing one or more items in the database, obtaining additional information from a database about one or more selected items, or other similar requests.

It should be noted that while FIG. 1 shows only a single computer system 170 and a single computer system 180, it is anticipated that the most preferred embodiments of the present invention will comprise hundreds and even thousands of computer systems 170 and computer systems 180. Each of these computer systems 170 and 180 will be configured to access data server 130 in an appropriately secure way so as to accomplish the specific objectives of the user of the computer system 170 or computer system 180. For example, the service provider that controls the databases stored on data server 130 may utilize computer system 170 or computer system 180 to access data server 130 and create or modify a given database. A shopper may use computer system 170 or computer system 180 to access data server 130 to retrieve information about ordering or purchasing desired items that are described in the database stored on data server 130, etc.

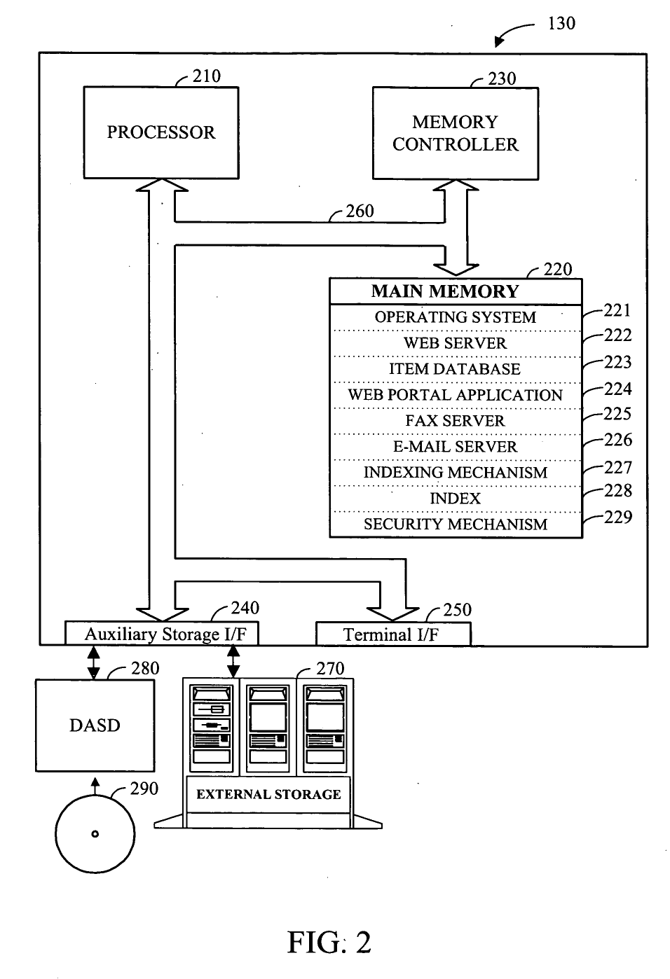

In the most preferred embodiments of the present invention, multiple computer systems 170 and multiple computer systems 180 will all be configured to communicate with data server 130 and with each other via network 120. In addition, the most preferred embodiments of the present invention include an Application Service Provider (ASP) environment where data server 130 is operated as a clearinghouse in a hosted operation. In this fashion, multiple computer systems 170 and computer systems 180 will have access to data server 130 and the databases stored thereon. Data server 130 is further described below in conjunction with FIG. 2 below.

Optional printer 110 and an optional fax machine 140 are standard peripheral devices that may be used for transmitting or outputting paper-based documents, notes, transaction details, reports, etc. in conjunction with the various requests and transactions processed by computer-based system 100. Optional printer 110 and an optional fax machine 140 may be directly connected to network 120 or indirectly connected to network 120 via any or all of computer systems 170, computer systems 180, and/or data server 130. Finally, it should be noted that optional printer 110 and optional fax machine 140 are merely representative of the many types of peripherals that may be utilized in conjunction with computer-based system 100. It is anticipated that other similar peripheral devices will be deployed in the various preferred embodiment of the present invention and no such device is excluded by its omission in FIG. 1.

Those skilled in the art will recognize that FIG. 1 depicts a fairly standard “client/server” type arrangement where data server 130 is considered to be a server and computers systems 170 and 180 are considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that must be transferred from a database to the user of system 100.

Referring now to FIG. 2, a data server 130 in accordance with a preferred embodiment of the present invention is a commercially available computer system such as a Linux-based computer system, IBM compatible computer system, or Macintosh computer system. However, those skilled in the art will appreciate that the methods and apparatus of the present invention apply equally to any computer system, regardless of the specific operating system and regardless of whether the computer system is a traditional “mainframe” computer, a complicated multi-user computing apparatus or a single user device such as a personal computer or workstation.

Data server 130 suitably comprises at least one Central Processing Unit (CPU) or processor 210, a main memory 220, a memory controller 230, an auxiliary storage interface 240, and a terminal interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 suitably executes one or more software programs contained within main memory 220.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a DVD or CD disk 290.

It is important to note that while the present invention has been (and will continue to be) described in the context of a fully functional computer system, those skilled in the art will appreciate that the various software mechanisms of the present invention are capable of being distributed in conjunction with signal bearing media as one or more program products in a variety of forms, and that the various preferred embodiments of the present invention applies equally regardless of the particular type or location of signal bearing media used to actually carry out the distribution. Examples of signal bearing media include: recordable type media such as DVD and CD ROMS disks (e.g., disk 290), and transmission type media such as digital and analog communication links, including wireless communication links.

In the most preferred embodiments of the present invention, various preferred embodiments of the program product may be configured to: create and modify multiple databases; configure and implement various search and retrieve functions for a multitude of search engines; update and transmit search results to one or more users; and provide one or more user interfaces for accomplishing all of these functions. In this fashion, the appropriate entities (i.e., vendors, consumers, etc.) can utilize the program product to initiate and complete a wide variety of database-related applications. Similarly, a program product in accordance with one or more preferred embodiments of the present invention can also be configured to perform substantially all of the steps depicted and described in conjunction with the figures below for implementing ecommerce shopping website search-and-retrieve and shopping functions and other similar transactions well known to those skilled in the art.

Memory controller 230, through use of an auxiliary processor (not shown) separate from processor 210, is responsible for moving requested information from main memory 220 and/or through auxiliary storage interface 240 to processor 210. While for the purposes of explanation, memory controller 230 is shown as a separate entity; those skilled in the art understand that, in practice, portions of the function provided by memory controller 230 may actually reside in the circuitry associated with processor 210, main memory 220, and/or auxiliary storage interface 240.

Terminal interface 250 allows users, system administrators and computer programmers to communicate with data server 130, normally through separate workstations or through stand-alone computer systems such as computer systems 170 and computer systems 180 of FIG. 1. Although data server 130 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired,-multi-drop bus, any connection means that supports bi-directional communication in a computer-related environment could be used.

Main memory 220 suitably contains an operating system 221, a web server 222, an item database 223, a web portal application 224, a fax server 225, an e-mail server 226, an indexing mechanism 227, an index 228 and a security mechanism 229. The term “memory” as used herein refers to any storage location in the virtual memory space of data server 130.

It should be understood that main memory 220 may not necessarily contain all parts of all components shown. For example, portions of operating system 221 may be loaded into an instruction cache (not shown) for processor 210 to execute, while other files may well be stored on magnetic or optical disk storage devices (not shown). In addition, although item database 223 is shown to reside in the same memory location as operating system 221, it is to be understood that main memory 220 may consist of multiple disparate memory locations. It should also be noted that any and all of the individual components shown in main memory 220 might be combined in various forms and distributed as a stand-alone program product. Finally, it should be noted that additional software components, not shown in this figure, might also be included.

For example, most preferred embodiments of the present invention will include a security and/or encryption mechanism 229 for verifying access to the data and information contained in and transmitted by data server 130. Security mechanism 229 may be incorporated into operating system 221 and/or web portal application 224. Additionally, security mechanism 229 may also provide encryption capabilities for computer-based system 100 of FIG. 1, thereby enhancing the robustness of computer-based system 100.

Once again, depending on the type and quantity of information stored in item database 223 and accessed by indexing mechanism 227, security mechanism 229 may provide different levels of security and/or encryption for different computer systems 170 and 180 of FIG. 1. Additionally, the level and type of security measures applied by security mechanism 229 may be determined by the identity of the end-user and/or the nature of a given request and/or response. In some preferred embodiments of the present invention, security mechanism 229 may be contained in or implemented in conjunction with certain hardware components (not shown this FIG.) such as hardware-based firewalls, switches, dongles, and the like.

Operating system 221 includes the software that is used to operate and control data server 130. In general, processor 210 typically executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, Web server 222 provides access, including a user interface, to allow individuals and entities to interact with web portal application 224, including via network 120 of FIG. 1.

Item database 223 is representative of any suitable database known to those skilled in the art. In the most preferred embodiments of the present invention, item database. 223 is a Structured Query Language (SQL) compatible database file capable of storing information relative to various items that may be of interest to the users of computer-based system 100 of FIG. 1. In the most preferred embodiments of the present invention, item database 223 will comprise a collection of information about various items that are made available for purchase via an ecommerce website offered in conjunction with web portal 224. Accordingly, item database 223 will typically contain item description information such as quantity, size, color, price, availability, etc. Those skilled in the art will recognize that other types of information for other types of data that may be used in other applications (e.g., historical, informational, technical, etc.) may be stored and retrieved as well. While item database 223 is shown to be residing in main memory 220, it should be noted that item database 223 may also be physically stored in a location other than main memory 220. For example, item database 223 may be stored on external storage device 270 or DASD 280 and coupled to data server 130 via auxiliary storage I/F 240.

Web portal application 224 is most preferably a software application configured to coordinate and manage the creation and implementation of various web-based database-related applications using computer-based system 100 of FIG. 1. Specifically, web portal application 224 is configured to process requests from the various entities that create and manage ecommerce websites as well as the various individuals or entities that may access the ecommerce website and conduct ecommerce transactions using web portal application 224. Access to web portal application 224 will generally be provided by a web browser interface installed at computer system 170 or computer system 180 of FIG. 1. Web portal application 224 also works in conjunction with indexing mechanism 227 to perform processing activities related to searching item database 223 and generating results that are provided in response to end-user requests. The most preferred embodiments of the present invention utilize XML for information exchange. Other data exchange formats known to those skilled in the art may also be utilized.

Fax server 225 is any fax server known to those skilled in the art and is configured to receive inbound fax messages and to transmit outbound fax messages. Fax server 225 may format and transmit any data processed by computer-based system 100 of FIG. 1 and make it available for use by any other component of computer-based system 100 of FIG. 1. Additionally, fax server 225 may process the data received and send it directly to web portal application 224 and make the incoming data for further processing by computer-based system 100, including indexing mechanism 227 and web portal application 224.

While not required, the most preferred embodiments of data server 130 of FIG. 1 will typically include an e-mail server 226. E-mail server 226 is any e-mail server application capable of being configured and used to send and receive various status messages and updates to data server 130 and between computer systems 170 or 180 of FIG. 1 via e-mail, as may be necessary to enhance the overall process of completing various indexing, search-and-retrieve and/or shopping transactions described herein. This includes the generation of automated e-mail messages relating to the order process and management of user account management and shopping transactions performed in accordance with the various preferred embodiments of the present invention. Automated e-mail messages are also generated to provide notifications regarding the status of the user account as well as shipping and billing information in accordance with the preferred embodiments of the present invention.

Indexing mechanism 227 is a software algorithm for generating one or more indices 228, based on the contents of item database 223. Indexing mechanism 227 will be invoked periodically to generate and/or update one or more indices 228 so as to provide an optimized search experience for the user of computer-based system 100 of FIG. 1. Additional information about Indexing mechanism 227 and index 228 is presented below.

Index 228 is representative of one or more indices that are generated by indexing mechanism 227. For the most preferred embodiments of the present invention, indexing mechanism 227 will generate multiple indices, including a “master index” and one or more “helper indices” that will be used to optimize the search results presented to a user of computer-based system 100 of FIG. 1.

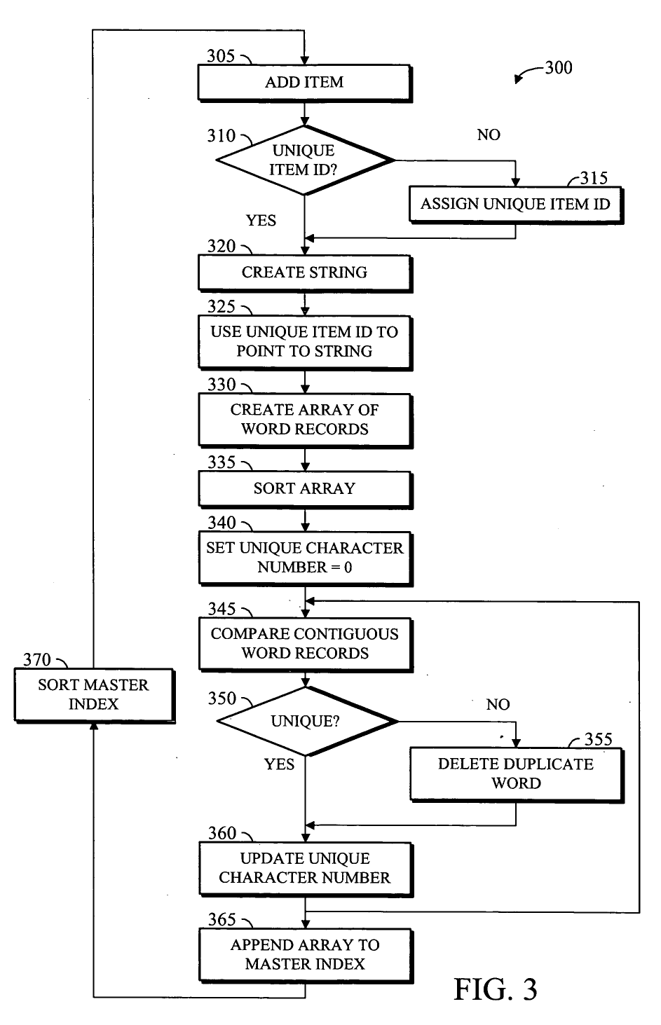

Referring now to FIG. 2 and FIG. 3, is a flow chart 300 for creating a database index 228 for optimized searching via a web-browser based search-and-retrieve mechanism in accordance with a preferred exemplary embodiment of the present invention. For this example, database index 228 is a “Master Index” which is an index containing one or more entries for all of the Candidate Items stored in item database 228. In the most preferred embodiments of the present invention, a separate entry is made into database index 223 for each distinct word in the Description for each Candidate Item. The actual indexing operation may be performed by indexing mechanism 227 and the results of any subsequent searching performed using index 228 will be transferred for display by web portal application 224.

As shown in FIG. 3, for each Candidate Item added to item database 223 (step 305), the Candidate Item needs to have a unique item ID (“UIID”). If a given Candidate Item does not have a UIID (step 310=“NO”), then a UIID will be assigned (step 315). If the Candidate Item already has a UIID associated with it (step 310=“YES”), then no UIID need be assigned. Once the UIID has been associated with the Candidate Item, a Description for the Candidate Item is created by concatenating the title and textual description of the Candidate Item (step 320) and the UIID becomes an electronic pointer to the string (step 325).

After ensuring that each Candidate Item has a UIID and the string for the Candidate Item has been created, an array of Word Records is created for that Candidate Item (step 330). In the most preferred embodiments of the present invention, a Word Record is created for each word contained in the Description for that Candidate Item. A typical Word Record will comprise the following fields: an item ID (the UIID assigned in step 315); a “Word” (i.e., a string of text that represents a given word); a “Position Number” that represents where in the Description that word is found; and a “Unique Character Number” that is used to enhance and optimize future searches involving the Candidate Item. Optionally, a word “Priority” field may also be assigned for those instances where a given word is deemed more relevant or important than the other words contained in a Description. For example, Words that are contained in the title for the Candidate Item may be deemed more relevant and, accordingly, assigned a higher Priority than words that come from the body of text describing the Candidate Item.

After the Word Record Array has been created with an entry for each word in the Description for a given Candidate Item, the Word Record Array may be sorted using the desired criteria (step 335). For the most preferred embodiments of the present invention, the sort order will be: Word (sorted alphabetically in ascending order) followed by Priority (sorted in descending order, if used) and then by Position Number (in ascending order). This sort order results in-the records contained in the Word Record Array being sorted in the manner most conducive to the elimination of duplicate words and the rapid retrieval of the Word Records during a search.

Once the Word Record Array has been sorted, the Unique Character Number of the first Word Record is set equal to “0” (step 340). Then, for each contiguous pair of Word Records in the Word Record Array (i.e., the first and second Word Records, the second and third Word Records, etc.) the Words in the respective Word Records are compared (step 345). If the Words match exactly (step 350=“NO”), the later occurring Word Record is a duplicate and may be deleted from the Word Record Array (step 355). If, however, the Words in the respective Word Records are unique (step 350=“YES”), then the Unique Character Number for the second word is set equal to the position of the first character for which the words are different (step 360).

Given this process, the Master Index typically starts out empty and the Word Records from the Word Record Array for each Candidate Item are inserted into the Master Index and then the Master Index can be sorted. In this fashion, the Master Index is most preferably created as the union or the sum total of all of the previously created Word Record Arrays (i.e., the index containing all Word Records for all Candidate Items in item database 223). If the Master Index has been previously created and new Candidate Items are to be added, then the new Word Record Arrays for the new Candidate Items can be created and appended to the Master Index. After appending a new Word Record Array, the Master Index may be sorted (step 370). Alternatively, the Master Index is sorted after-all initial or new Candidate Items have been added, instead of after each individual Word Record Array has been inserted. In the most preferred embodiments of the present invention, the Master Index will be sorted by Word (in ascending alphabetical order) followed by word Priority (in descending order, if used).

One aspect of the preferred embodiments of the present invention that facilitates more efficient searching is the use of the Unique Character Number described above. In a typical database index that does not employ the Unique Character Number of the present invention, it is relatively easy to identify the range of contiguous Word Records that match a given Partial Word. However, it is very possible that a given Candidate Item will appear multiple times in this range if its Description contains two or more different words that both begin with the same Partial Word. For ease of interpreting the search results and to minimize the amount of data transferred in response to a given query, these duplicate entries should be deleted.

One way to eliminate these duplicates is to simply iterate through each of the Word Records that match the Partial Word and generate a list of UIIDs that are selected. For each subsequent Word Record encountered in the iterative process, the list of UIIDs may be checked to determine if the UIID has already been entered into the list. If it has, the duplicate record will simply be skipped. Alternatively, a copy of all relevant Word Records may be made in another area of memory. These Word Records may then be sorted using the UIID and any duplicates can then be identified and eliminated. The Word Records may then be resorted in their original order and used in that order. This approach is the type of approach that may be taken by a general-purpose-database server product like SQL Server® or Oracle®.

While these approaches are effective, both require additional processing time and computer memory. In a client/server environment, additional memory must be allocated on the server for each client search that is performed. Additionally, since users perceive a search application to be much faster if the first few results can be displayed as soon as possible, it is more desirable to have the server send the results back a few at a time. This makes it very cumbersome to save additional data structures for each client search that is performed.

In contrast, the Unique Character Number of the present invention is more efficient because, for a given matching Partial Word range and a given Word Record contained in that range, there is an earlier appearance of the same Candidate Item in that range if and only if the Partial Word length is less than the Unique Character Number in the Word Record. Comparing the Partial Word length to the Unique Character Number is the most efficient way to eliminate duplicates and requires almost no time and no extra memory allocation. The obvious way to eliminate duplicate records is to compare the Unique Character Number to the Partial Word Length as the Word Records are examined and simply ignore the Word Records that fail the test.

This method of eliminating duplicates works in a client/server environment, as well. The server can quickly and efficiently return results (with duplicates eliminated) for a Partial Word search without allocating extra memory. Additionally, the results can be returned in small portions with very little extra processing required.

Additionally, in a typical client/server environment, there is yet another option for handling duplicate entries. The server can return all of the matching results to the client, including duplicate records, but also return the Unique Character Number with each search result. Then, the client computer can compare the Unique Character Number to the Partial Word length and, by eliminating those records where the Partial Word length is less than the Unique Character Number in the Word Record, avoid displaying the duplicates. By storing all of the search results in local memory on the client computer, whenever the user adds more characters on the end of the original Search Term, the client computer can narrow down the set of Matching Items without needing to further communicate with the server at all. This can save a considerable amount of time in many application environments.

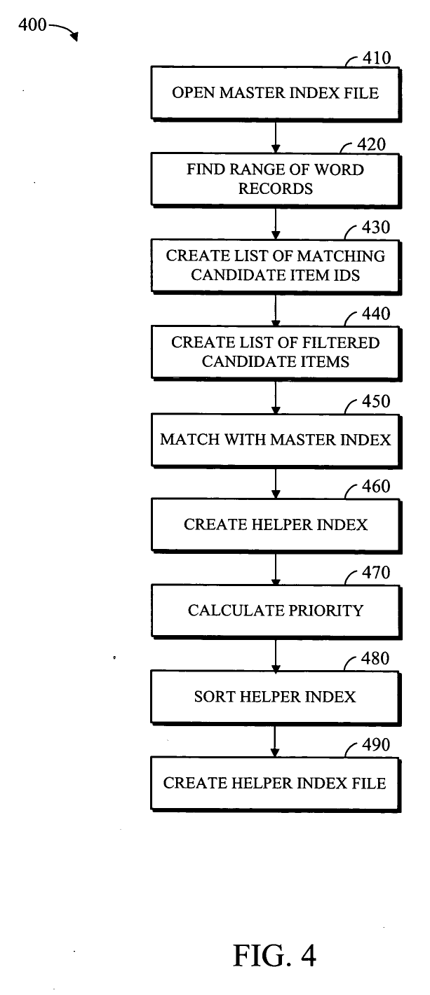

Referring now to FIG. 4, a flow chart 400 for creating a helper database index for optimized searching via a web-browser based search-and-retrieve mechanism in accordance with a preferred exemplary embodiment of the present invention is depicted. In the most preferred embodiments of the present invention, whenever the Search Term consists of more than a single word, the server will utilize a helper index to search the database. In this case, the last word will be the “Final Word” and the earlier words will be “Initial Words.” For example, if the Search Term is “Valentines day paper,” then “paper” is the Final Word and “Day” and “Valentines” are the Initial Words. To respond to the search request, the Helper Index corresponding to the set {Day, Valentines} will be utilized. If this specific Helper Index does not exist at the time of the search, then it will be created, as described in conjunction with FIG. 4 and as detailed below. Then, within this Helper Index, the Final Word “paper” will be located and the matching items will be returned as a search result.

As shown in FIG. 4, to create a Helper Index, the Master Index file is first opened for access (step 410). Then, for each of the words in the set of Initial Words, the range of Word Records contained in the Master Index that match that Initial Word is identified (step 420) and a list of Candidate Items is created (step 430) by iterating through the matching Word Records in the identified range and adding the UIID for each relevant Word Record to the list. If Priorities are contained in the Word Record, it may be desirable to include that information in the list or, alternatively, to create a pointer to the relevant Word Records or a copy of the relevant Word Records. This will allow for the sorting of the Word Records based on Priorities in the future.

Next, the lists of Candidate Item UIIDs are combined into a list of Filtered Candidate Items (step 440) by noting the intersection of Word Records for each list and selecting only those UIIDs for those Candidate Items that appear on each individual list. The Word Records in the Master Index that have UIIDs that appear in the Filtered Candidate Item list will be identified (step 450) and inserted into the Helper Index (step 460). Then the Priority for each Word Record in the Helper Index can be calculated (step 470) and entered into the appropriate field for each Word Record contained in the Helper Index and the Helper Index can be sorted (step 480). In the most preferred embodiments of the present invention, the Helper Index is sorted alphabetically (ascending) and then by Priority (descending). Finally, the Helper Index is written to disk and becomes the Helper Index file (step 490).

In the most preferred embodiment of the present invention, the numbers “0” and “1” are used to indicate one type of Priority number. For example, a “1” will be stored as the Priority if the word appears in the descriptive title for that Candidate Item and a “0” will be stored as the Priority if the word does not appear in the descriptive title for that Candidate Item. When the UIID lists are combined to create the list of Filtered Candidate Items (step 440), an additional supplemental priority number, the sum of the Priority numbers stored with that specific UIID, is also stored in the list of UIIDs.

For each Word Record that is copied into the Helper Index (step 450), the Priority number is calculated as the sum of the Priority number from the Word Record in the Master Index and the supplemental Priority number stored with that UIID in the list of Filtered Candidate Items. When computed in this manner, the Priority for each Word Record in the Helper Index represents how many Search Term words will be found in the product title when that Word Record matches a Search Term.

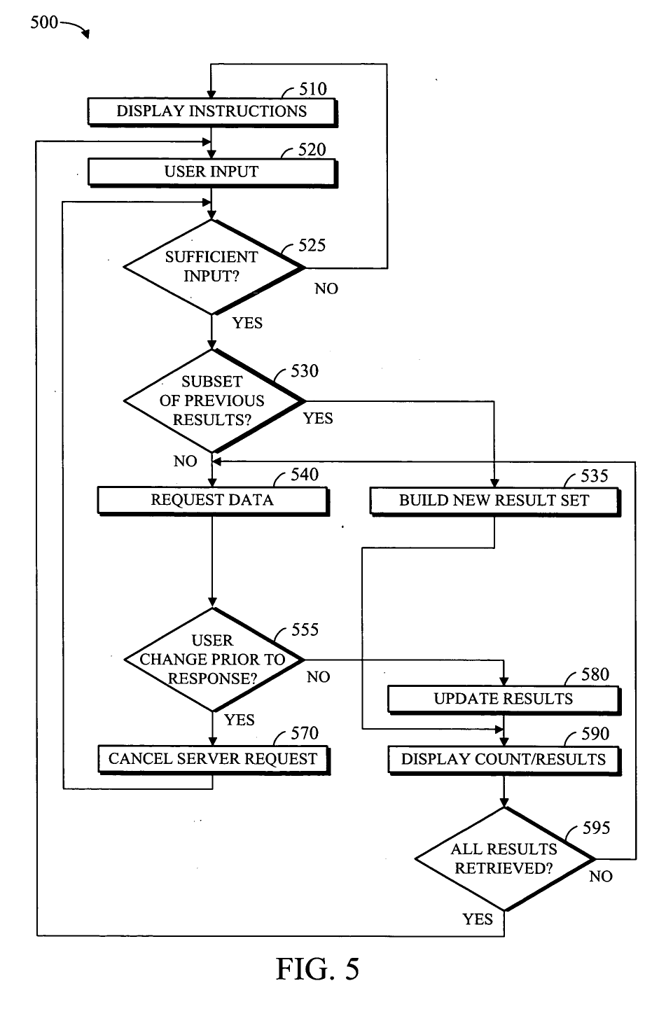

Referring now to FIG. 1, FIG. 2 and FIG. 5, is a flow chart 500 for a method of enhanced database access for a user utilizing a web-browser based search-and-retrieve mechanism in accordance with a preferred exemplary embodiment of the present invention. In this case, the user of computer-based system 100 will access data server 130 via network 120 from computer system 170 or computer system 180. The user will optionally be presented with the instructions (step 510) in case the user is unfamiliar with the search request methodology. The user will begin to input their search request (step 520) and the input will be evaluated to determine whether or not enough characters have been input by the user to initiate the search request to data server (step 525).

If the user input is not sufficient to initiate a search request to data server 130 (step 525=“NO”) then the cycle will repeat by returning to steps 510 and 520. The exact amount of data required to initiate a search request will depend on the specific application and system-related performance factors such as latency time, network traffic, etc. In general, the decision as to the amount of data required to initiate a search will be determined so as to provide the most helpful user response and so as to avoid unnecessary typing. For example, while the search results could be returned or updated based on a single keystroke, this implementation would most likely result in an undesirably large number of results being returned. Large numbers of results that don't identify the desired items can be distracting and counterproductive. In any case, once the user input is sufficient to initiate a search request (step 525=“YES”), then any previous search requests can be reviewed to determine whether or not the current search request is a subset of a previous search request (step 530).

If the current search request is not a subset of a previous search request (step 530=“NO”) then data will be requested from data server 130 (step 540). Once the data is received from server 130, a check will be performed to determine whether or not the user has changed the search request during the time it took data server 130 to respond to the request for data (step 555). If the user has not changed the search request in the interim (step 555=“NO”) then the search results will be updated (step 580) and the results will be displayed for the user (step 590). If the user has changed the search request in the interim (step 555=“YES”) the server request will be cancelled (step 570) and the results returned by data server 130 will not be used. Instead, the method will return to step 525 to determine once again if a sufficient amount of data has been entered to initiate another server request. After the results have been displayed, the search request can be evaluated to determine whether or not all matching results have been retrieved (step 595). If all results have been retrieved (step 595=“YES”) then the method returns to await additional user input (step 520). If all of the pertinent results have not been retrieved (step 595=“NO”) then the method will return to request more data (step 540).

If the current search request is a subset of a previous search request (step 530=“YES”) then the new search result set will be created by removing any previous results that do not match the current search request (step 535) and the results will be displayed for the user (step 590). After the results have been displayed, the search request can be evaluated to determine whether or not all matching results have been retrieved (step 595). If all results have been retrieved (step 595=“YES”) then the method returns to await additional user input (step 520). If all of the pertinent results have not been retrieved (step 595=“NO”) then the method will return to request more data (step 540).

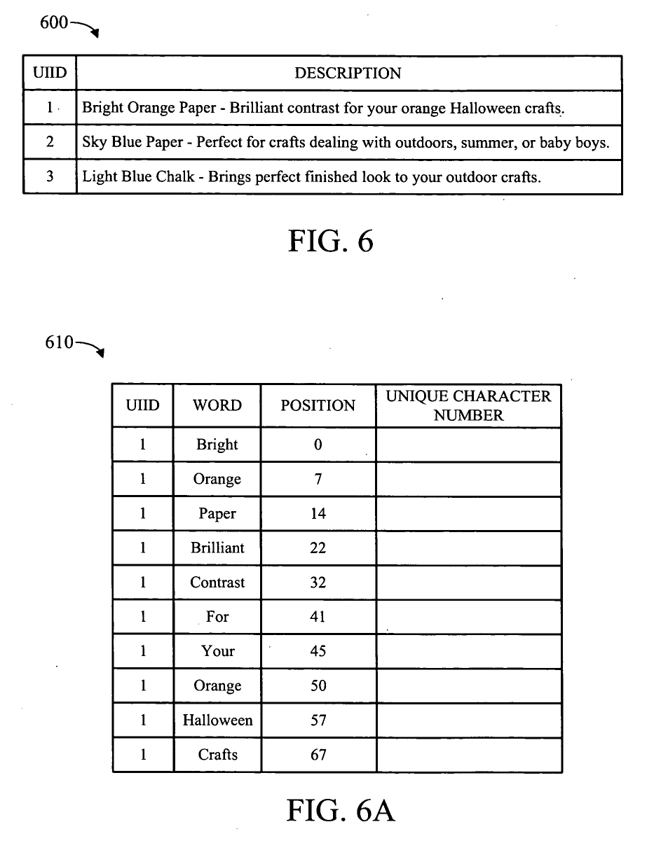

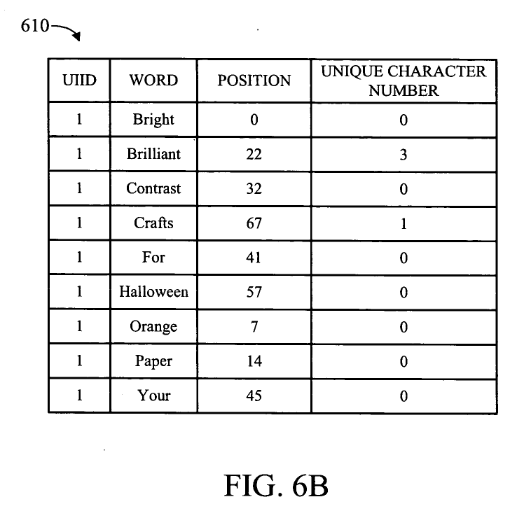

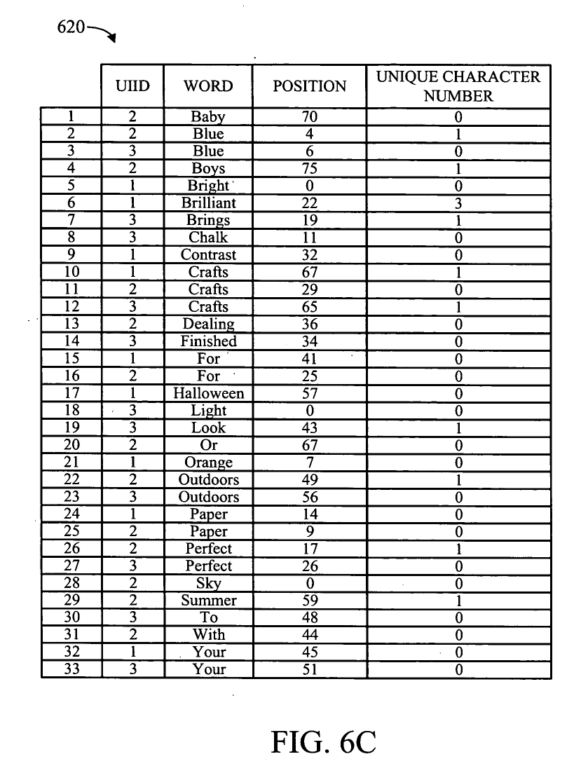

Referring now to FIGS. 6, 6A, 6b, and 6C, the process of creating a Master Index is illustrated by a series of schematic tables for a selected group of Candidate Items. These schematic tables are constructed using the steps outlined in conjunction with method 300 of FIG. 3. Starting with FIG. 6, three Candidate Items from table 600 are to be added to a Master Index and Each Candidate Item has been assigned a UIID (1, 2, or 3).

Table 610 of FIG. 6A depicts a Word Array constructed using the first Candidate Item from table 600 of FIG. 6 where each of the words contained in the title and description for the first Candidate Item from Table 600 has been used to create a Word Record. The position number for each word indicates the starting position for the first letter of each word when all of the words contained in the title and description for the first Candidate Item have been concatenated into a single string.

In FIG. 6B, table 610 has been reordered (e.g., the Word Records in the Word Array have been alphabetized and the Word Record for the duplicate word “orange” has been removed). Additionally, a unique character number has been assigned for each Word Record, based on the comparison made between each word and the preceding word. Finally, in table 620 of FIG. 6C, a complete Master Index for the Candidate Items shown in table 600 of FIG. 6 is shown. This Master-Index has been constructed using the Word Arrays for each of the three Candidate Items. The Word Records from the Word Arrays for Candidate Items with UIID of 2 and 3 (with the Word Arrays the second and third Candidate Items having been constructed in essentially the same manner as the Word Array for the first Candidate Item) have been inserted and sorted alphabetically. The sequential numbers shown on the left of table 620 are included for ease of reference.

Using the Master Index shown in Table 620 of FIG. 6C, a simple search can be illustrated. If the Search Term is “Paper” then the matching results set will be entries 24 and 25 from the Master Index and both of these results will be returned to the user for display because the Unique Character Number for both words in these Word Records are 0, indicating that the length of the words is than the length of the search term (in this case, 5).

If the Search Term is “Bri” then the results returned to the user will be entries 5 through 7. However, the Word Record at entry 6 is easily recognized as a duplicate because the Unique Character Number for entry 6 is “3,” which is not less than the length of the search term (3). Additionally, the duplication can also be recognized by noting that the UIID for entry 5 and entry 6 is the same. Accordingly, it is not necessary to display entry 6 to the user at this time.

However, if the Search Term were expanded to “Bril,” then the relevant result set will consist of entry 6 only and since the length of the Search Term is now “4,” which is greater than the unique character number for entry 6, then entry 6 should be displayed to the user in the result set. As previously discussed, it may be preferable for this “narrowing down” of the results for display to the user to happen on the client computer without any communication from the server, which is possible if the server is configured to send the Unique Character Number with each Word Record extracted during the search.

Using this search-and-retrieve methodology, intermediate search results may be returned to the user while the user is still formulating the search request. This approach is especially useful for databases containing a very large number of candidate items and allows for the prompt retrieval and display of the most pertinent items in a relatively short amount of time. In at least some cases, the intermediate search result will be enough for the user to make a decision and the search process may be terminated more rapidly. This is in contrast to most search-and-retrieve methodologies that require a complete search request to be formulated and submitted prior to initiating any search.

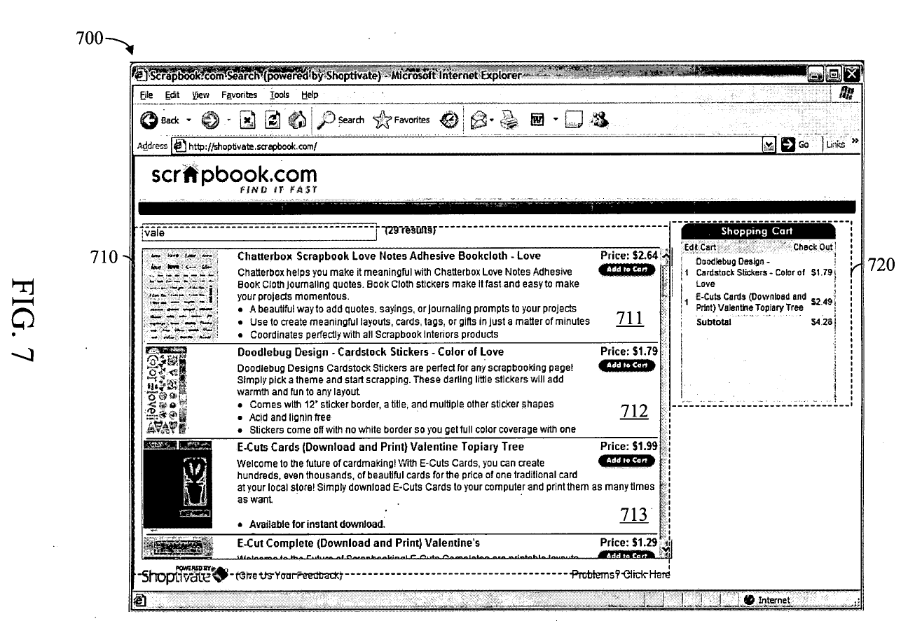

Referring now to FIG. 7, a schematic representation of a user interface 700 for providing access to a version of the web-browser based search-and-retrieve mechanism of the present invention customized optimized online shopping is shown. User interface 700 is one specific implementation of an on-line search-and-retrieve application that can be deployed using the various preferred embodiments of the present invention.

As shown in FIG. 7, a search engine interface 710 is used to search an online database and, depending on the search parameters, return one or more items of interest from the online database. In this case, the search of the database has returned 29 matching items, three of which (item 711, item 712, and item 713) are displayed in search engine interface 710. Items 711, 712, and 713 have all been retrieved from an on-line database using the master index and/or helper index functionality previously described. This allows the search to be completed more rapidly than would otherwise be possible using previous types of search-and-retrieve functionality.

In addition to search engine interface 710, a shopping cart interface 720 is also included in user interface 700. In this manner, once a user selects an item from search engine interface 710 that item is then displayed in shopping cart interface 720. This interactive process allows the user of user interface 700 to simultaneously search for new items while viewing the previously purchased items in shopping cart interface 720. This functionality will largely obviate the time-wasting activity associated with presently known search and shop websites, saving time and allowing the shopper to be more efficient and effective in the shopping process.

In summary, the present invention provides broad application of a unique search-and-retrieve application for rapid database access where consumers, vendors, researchers and the like are all benefited and served by the methods and integrated processes comprehended by the various preferred embodiments of the present invention. By implementing various preferred embodiments of the present invention, many useful applications that rely on ready access to large databases can be constructed and maintained.

Lastly, it should be appreciated that the illustrated embodiments are preferred exemplary embodiments only, and are not intended to limit the scope, applicability, or configuration of the present invention in any way. Rather, the foregoing detailed description provides those skilled in the art with a convenient road map for implementing a preferred exemplary embodiment of the present invention. Accordingly, it should be understood that various changes may be made in the function and arrangement of elements described in the exemplary preferred embodiments without departing from the spirit and scope of the present invention as set forth in the appended claims.

1. An apparatus comprising:
a processor;
a memory coupled to said processor;
an item database residing in said memory, said item database comprising a plurality of candidate items, each of said candidate items being described by at least one word; and
an indexing mechanism, said indexing mechanism creating at least one index comprising a plurality of word arrays, each of said plurality of word arrays comprising a plurality of word records, each of said plurality of word records containing at least one word from at least one of said candidate items.

2. The apparatus of claim 1 further comprising a web portal application, said web portal application providing a user interface for accessing at least one search result based on said at least one index.

3. The apparatus of claim 1 wherein said indexing-mechanism is configured to remove duplicate word records from said at least one index.

4. The apparatus of claim 2 further comprising a security mechanism, said security mechanism providing encryption functionality for said web portal application.

5. The apparatus of claim 1 further comprising at least one helper index in said memory, said at least one helper index comprising a subset of said a plurality of word arrays.

6. The apparatus of claim 1 further comprising a network coupled to said memory, said network being connected to a computer system.

7. The apparatus of claim 1 wherein said web portal application further comprises a user interface displayed in a single web browser window, said user interface comprising:
a search engine interface, said search engine interface being configured to provide a search-and-retrieve functionality;
a shopping cart interface, said shopping cart interface being configured to provide a visual representation of items purchased, said shopping cart interface and said search engine interface and being updated in real time and being displayed simultaneously in said single web browser window.

8. The apparatus of claim 1 further comprising:
a web portal application residing in memory, said web portal application providing a user interface for accessing at least one search result based on said at least one index, said user interface comprising:
a search engine interface, said search engine interface being configured to provide a search-and-retrieve functionality; and
a shopping cart interface, said shopping cart interface being configured to provide a visual representation of items purchased, said shopping cart interface and said search engine interface being updated in real time and being simultaneously displayed in a single web browser window;
at least one helper index in said memory, said at least one helper index comprising a subset of said a plurality of word arrays;
a security mechanism, said security mechanism providing encryption functionality for said web portal application;
a web server residing in said memory;
an email server residing in said memory; and
a fax server residing in said memory.

9. The apparatus of claim 1 further comprising:
a web server residing in said memory;
an email server residing in said memory; and
a fax server residing in said memory.

10. A method comprising the steps of:
a) creating a candidate item database, said candidate item database comprising a plurality of candidate item records, each of said candidate item records identifying a candidate item; and
b) indexing said candidate item database by:
assigning a unique item ID to each of said plurality of candidate item records;
concatenating a plurality of descriptive words from each candidate item record, said descriptive words describing each of said plurality of candidate items, thereby creating a string for each of said plurality of candidate items;
creating a word array for each of said candidate items, said word array containing a word record for each of said descriptive words in each of said strings, thereby creating a plurality of word arrays; and
arranging said plurality of word arrays into a searchable index.

11. The method of claim 10 further comprising the step of assigning a unique character number for each of said descriptive words, said unique character number being used to identify matching results to display in response to a search of said candidate items.

12. The method of claim 10 further comprising the step of using said index to provide a search result in response to a search request.

13. The method of claim 10 further comprising the step of assigning a priority number to each of said plurality of descriptive words.

14. The method of claim 10 further comprising the step of sorting said searchable index alphabetically.

15. The method of claim 10 further comprising the step of sorting said searchable index alphabetically and by priority number.

16. The method of claim 10 further comprising the steps of:
displaying a search engine interface in a browser window, said search engine interface being configured to provide a search-and-retrieve functionality; and
simultaneously displaying a shopping cart interface in said browser window, said shopping cart interface being configured to provide a visual representation of items purchased, said shopping cart interface and said search engine interface being updated in real time.

17. The method of claim 10 further comprising the steps of:
creating at least one search request; and
using said at least one search request and said index to return at least one search result from said candidate item database, wherein said at least one search result is returned while said at least one search request is still being formulated.

18. A program product comprising:
an indexing mechanism, said indexing mechanism being configured to create at least one index comprising a plurality of word arrays, each of said plurality of word arrays comprising a plurality of word records, each of said plurality of word records containing at least one word from at least one of said candidate items; and
signal bearing media bearing said indexing mechanism.

19. The program product of claim 18 further comprising a web portal application, said web portal application being configured to provide a user interface for accessing at least one search result based on said at least one index, said user interface comprising:
a search engine interface, said search engine interface being configured to provide a search-and-retrieve functionality; and
a shopping cart interface, said shopping cart interface being configured to provide a visual representation of purchases, said shopping cart interface and said search engine interface being updated in real time and being displayed simultaneously in a single web browser window.

20. The program product of claim 18 wherein said indexing mechanism is configured to create a master index and at least one helper index, said helper index comprising a subset of said master index.

21. The program product of claim 18 wherein said signal bearing media comprises recordable media.

22. The program product of claim 18 wherein said signal bearing media comprises transmission media.
